(19) United States
(12) Patent Application Publication
(10) Pub. No.: US 2016/0086265 A1
(43) Pub. Date: Mar. 24, 2016

(54) System and Method of Relative Channel Capacity based securities trading

(71) Applicant: Edgar Parker, JR., Bayside, NY (US)

(72) Inventor: Edgar Parker, JR., Bayside, NY (US)

(21) Appl. No.: 14/492,007

(22) Filed: Sep. 20, 2014

(51) Int. Cl. G06Q 40/04

(52) U.S. Cl. CPC G06Q 40/04

(57) ABSTRACT

A trader at a specific location from a market or markets may have advantages in trading some securities over other securities. Relative channel capacity analysis could reveal specifically which securities that the trader's location would favor in terms of trading at the market or markets. Additionally the trader could use the relative channel capacity analysis to determine which securities she might have an advantage or disadvantage in trading relative to other traders at other locations.

### RELATED APPLICATIONS

The present application claims the benefit under 35 U.S.C. .sctn.119(e) of U.S. Provisional Application Ser. No. 61/880,907, filed Sep. 21, 2013, entitled “System and Method of Relative Channel Capacity based securities trading,” which is incorporated herein by reference in its entirety.

### REFERENCE

“Efficient Markets Meet the Shannon Limit,” 1^{st} edition and 2^{nd} editions authored by the inventor of the present application Edgar Parker, Jr. and published on Amazon Digital Services, Inc. in September 2013 and September 2014 respectively which are incorporated herein by reference in its entirety.

### SUMMARY

The trader would need to select securities that will not result in a violation of the relative channel capacity limits. The trader would need to be able to receive and communicate information to each market before price changes (or any price changes outside desired limits) caused trading opportunities to evaporate (or have a much lower probability of success). A security or securities must be selected that would allow the two relations CC_{LA}≧2CC_{A}(T_{LA}/T_{A}), CC_{LB}≧2CC_{B}(T_{LB}/T_{B}) to be true.

Where a trader is located at a position X between two markets A and B. CC_{LA} and CC_{LB} are the channel capacities (bits/second) of the trader's communication links to the markets A and B respectively. L_{A}, L_{B}=(Distance from A or B to X respectively). Information travel times along L_{A} are L_{B} are to and from the markets are given by T_{LA}=L_{A}/(C/index of refraction) and T_{LB}=L_{B}/(C/index of refraction). CC_{A} and CC_{B} are the information generating rate (bits/second) of the price series at markets A and B.

Instead of CC_{A} and CC_{B} the volatilities of the tested security can be utilized as seen in CC_{LA}≧2kσₐ(T_{LA}/T_{A}) CC_{LB}≧2kσ_{b}(T_{LB}/T_{B}). Here σₐ and σ_{b} are the volatilities of a single security at markets A and B respectively and k is an adjustment factor (k may be set to 1 for simplicity). Securities that satisfy both equations will not violate the Shannon limit and will have a higher probability of successful trades when compared with securities that violate the relative channel capacity relations. These (Or equivalently to be excluded from possible trading).

Note the same analysis could be performed on a communication link connected to just one market. In that case the endpoint where the trader, computer, and/or server is located is X which is some measureable physical distance from the desired market. The same relation would need to hold CC_{LA}≧2CC_{A}(T_{LA}/T_{A}), or CC_{LA}≧2kσₐ(T_{LA}/T_{A}) for the optimal relative channel capacity based selection of securities to be possibly traded (Or equivalently to be excluded from possible trading).

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 an illustrative diagram of process 100 which is an exemplary the optimal relative channel capacity based selection of securities to be traded in accordance with some embodiments of the present disclosure. Information arrives at markets A and B (101 and 102) at rates Ra=Ra respectively. Rates Ra and Rb can be measured in bit/sec or by the standard deviations (or volatilities) of σₐσ_{b} of the prices Pa and Pb (where Pa and Pb are the prices of the same commodity or security at market A and B respectively. Securities that satisfy the relationships dictated by the relative channel capacity equations are selected for trading by a traded located between the markets. CC_{LA} and CC_{LB} are the channel capacities of the fiber optical or other communication link between markets A and trading point X (103), and between market B and trading point X respectively. L_{A} and L_{B} are the distances from the markets A and B to the trading point X respectively. T_{LA} and T_{LB} are the times it takes signals to travel from markets A and B to trading point X respectively.

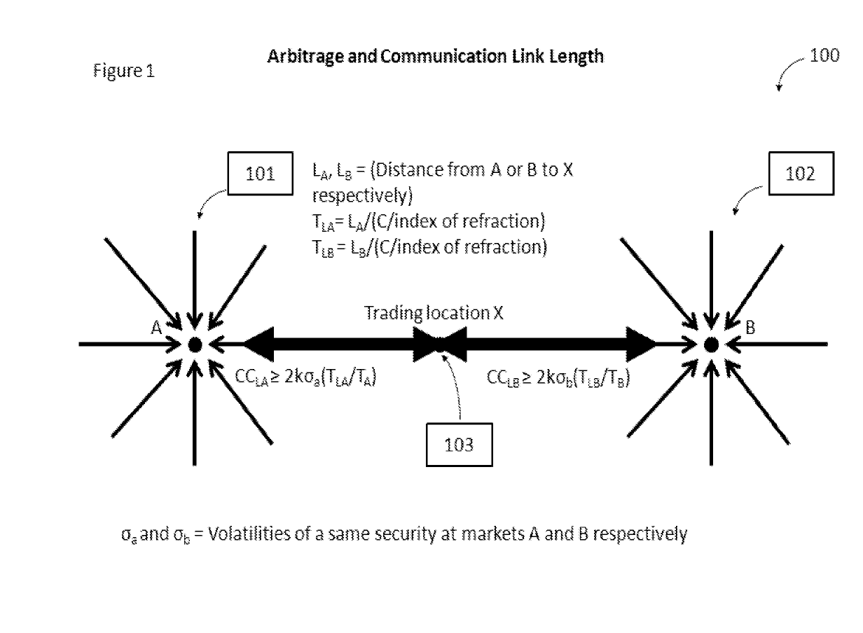

FIG. 2 is a block diagram generally illustrating an example of a computer system that may be used in implementing aspects of the present disclosure. The computer system may have one or more processors 210, one or more non-transitory computer storage media 220 or memory, and one or more non-volatile storage media 230. The processor 210 may execute one or more instructions stored in one or more computer-readable storage media (or memory 220).

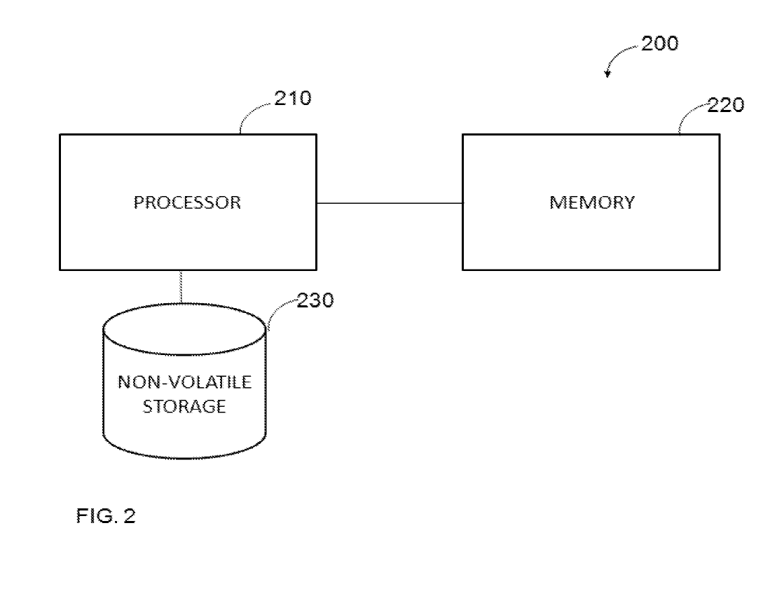

### BACKGROUND

### Relative Channel Capacity

In the preceding discussion the interplay of the rate of information arrival and processing at the local market versus the rate of information transport along the fiber optic cable length determined Lₘₐₓ. Where Lₘₐₓ=(CC_{L}*T_{A}* c)/2CC_{A}*index of refraction). The key concepts are the channel capacities of the individual markets CC_{A} or CC_{B} (CC_{A}=CC_{B} for simplicity can be easily generalized to CC_{A}≠CC_{B} without changing main results) versus that of the communication link CC_{L} connecting the markets. These are related by the relative amount of time T_{L}/T_{A} that it takes the same signal to traverse the link versus the average time between the arrival of new information at the markets. In actual calculations measures such as volatility prices change per time period may be used as a proxy for market or individual security channel capacity. This relationship between the temporally adjusted channel capacities of the communication link and the markets will be referred in this work hereafter as the Relative Channel Capacity (RCC) of the linked system. The familiar standard channel capacity (CC=#bits/1 sec transmission rate at any point on the cable) of the cable stays the same no matter its length. However, information must travel from Markets A, B through link L at least as fast as it arrives at the markets to avoid information loss. The loss of information can be thought of the loss of a price signal, the insertion of a false signal, the lagging or delay of a price signal beyond immediate arbitrage time relevance. This relationship is captured in the following equation: CC_{L}≧2CC_{A}(T_{L}/T_{A}). Specifically this relationship models a roundtrip communication from market A to B or B to A. The roundtrip is needed first to detect a price difference at the opposite markets and then to send of buy/sell responses to the opposite markets.

Formally RCC is the traditional channel capacity of the market participant relative to the volatility of the price series and to the participant's distance from the market (L). Relative Channel Capacity is described by the equations below:

CC_{L}≧2CC_{A}(T_{L}/T_{A}); RCC=CC_{L}/2CC_{A}(T_{L}/T_{A})≧1 or (CC_{L}/2)(2I(σ))(T_{L}/ΔT)≧1
RCC=Relative Channel Capacity
L=physical distance from the market
CC_{L}=channel capacity of the market participant
I(σ)=CC_{A}=information generation rate of the volatility of the price series at time scale ΔT
T_{message length}=(Price or buy/sell message size of X bits)/CC_{L}=X bits/CC_{L}
Tₘₐₓ=(CC_{L}*ΔT)/2I(σᵢ) is the maximum RCC derived time T_{L} to complete the 1 way communication, and T_{C}=Computation Time

A quick explanatory note about the T_{L} variable follows. The true total one-way communication time to the market is denoted by by T_{L}=T_{Speed of link}+T_{message length} or T_{L}=L/(c/IR)+Xbits/CC_{L}; where Xbits is the message length. For the market (or the price generating mechanism) the number of prices generated per period determines the number of bits generated per time period which can be described as Xbits=CC_{A}Δt. The price or information messages sent and the trader's buy and sell responses are assumed to be composed of a similar number of bits for simplicity. This assumption can be easily relaxed without affecting the overall analysis to follow. Later in the paper is CC_{A} is assumed to incorporate the total information that may be used in analyzing a security, and not just the price series as seen in this section.

T_{L} can be elucidated by a simple analogy to a train traveling from point A to point B. Replace channel capacity and bits with train speed and train length respectively. The front of the train takes T_{train front} seconds (Speed*distance) to move from A to B. However the rear of the train reaches B at some time later than the front at time T_{train front}+T_{train length in time}. Where T_{train length in time}=(Train Speed*train length). Therefore T_{L}=((Train Speed*distance)+(Train Speed*train length)). Similarly T_{L}=L/(c/IR)+Xbits/CC_{L}+T_{C}. [Where T_{C} is the time needed to calculate the existence of and execution of a hypothetical trade (i.e. total computer and computer program speed). In most of the paper T_{C} will be assumed to be included in T_{L} when not explicitly mentioned].

If the market participant's RCC<1 (or equivalently T_{L}>Tₘₐₓ), the price series at time scale ΔT will change before roundtrip communication with the market is completed. The market participant is not able to interact with the complete price series and important variables such as the true volatility experienced by the market participant will be affected.

The relationship additionally illustrates changes in the system dynamics as the variables are changed. As the distance between the markets grows the length L of the communication link must also grow. As L increase so does the time T_{L} (T_{L}=L/(C/index of refraction)+Xbits/CC_{L}) that it takes for information to travel from A to B and vice versa. If we hold all other variables constant then ΔCC_{L}=Δ2T_{L}, and the channel capacity of the link must grow at least twice as fast as the link's length to avoid information loss.

### Continuum of Arbitrage Dynamics as L Varies

To motivate the discussion first assume there is some distance L at which it makes economic sense to construct a proprietary communication network between markets for the purpose of latency arbitrage. Economic sense would imply that CC_{L}≧2CC_{A}(T_{L}/T_{A}) which means that the communication link owner market could at either end receive price information and respond to that information before prices change again. Also assume that other market participants cannot also create a similar link (perhaps the current link owner owns land between the markets and refuses to allow competitor construction). Define K- to be the minimally profitable separation between prices of the same commodity at the geographically distanced markets A and B. Also assume that K(t₀)=K-=|Pa(t₀)−Pb(t₀)| When the trades are completed at or before time t₁, then K(t₁)=|Pa(t₁)−Pb(t₁)|=K(t₀)=|Pa(t₀)−Pb(t₀)|=K-.

Prices changing before the market participants can react can be seen as a loss of information. At Lₛₘₐₗₗ<<Lₘₐₓ the rate of transmission between markets CCLₛₘₐₗₗ>>CC_{A} or CC_{B} would greatly exceed information arrival at the individual markets from the outside world. L could be gradually increased with no loss of information as long as CC_{L}>>2CC_{A}(T_{L}/T_{A}). As long as this condition is satisfied the traders will know with certainty that the observed prices Pa and Pb will remain in effect until their trades are completed as seen in the discussion above. The traders' latency advantage gives them certain profits.

However at some length greater than Lₘₐₓ, CC_{L}<2CC_{A}(T_{L}/T_{A}) and the prices observed at t₀ change before the market participants' trades are completed at time t₁.

The traders can no longer be certain of their latency based profits if price changes are missed. In fact as L increased beyond Lₘₐₓ the traders go from 100% certainty of profits to only expecting profits 50% of the time when observing K(t₀)=|Pa(t₀)−Pb(t₀)|, since half of the values of K now fall above and below K- (Where K-=minimally profitable separation between prices).

1. A method for the determination of the optimal selection of securities to be traded by a trader who is located along a communication link a certain distance from a single market;
using a computer, and/or server which is programmed to select for trading those securities that satisfy the relationships CC_{LA}≧2CC_{A}(T_{LA}/T_{A}) and/or CC_{LA}≧2kσₐ(T_{LA}/T_{A}).

2. A method for the determination of the optimal selection of securities to be traded by a trader, who is located along a communication link between at least two markets; using a computer, and/or server which is programmed to select for trading those securities that satisfy the relationships CC_{LA}≧2CC_{A}(T_{LA}/T_{A}), CC_{LB}≧2CC_{B}(T_{LB}/T_{B}) and/or CC_{LA}≧2kσₐ(T_{LA}/T_{A}), CC_{LB}≧2kσ_{b}(T_{LB}/T_{B}).

3. A method for the determination of the optimal selection of securities to be excluded from trading by a trader who is located along a communication link a certain distance from a single market; using a computer, and/or server which is programmed to select for exclusion from trading those securities that do not satisfy the relationships CC_{LA}≧2CC_{A}(T_{LA}/T_{A}) and/or CC_{LA}≧2σₐ(T_{LA}/T_{A}).

4. A method for the determination of the optimal selection of securities to be excluded from trading by a trader, who is located along a communication link between at least two markets; using a computer, and/or server which is programmed to select for exclusion from trading those securities that do not satisfy the relationships CC_{LA}≧2CC_{A}(T_{LA}/T_{A}), CC_{LB}≧2CC_{B}(T_{LB}/T_{B}) and/or CC_{LA}>2kaₐ(T_{LA}/T_{A}), CC_{LB}≧2kσ_{b}(T_{LB}/T_{B}).
Steps for claim 1:
1. A group of securities potentially desired to be traded are tested on a computer or computer server using a computer program for the satisfaction of relationships CC_{LA}≧2CC_{A}(T_{LA}/T_{A}) and/or CC_{LA}≧2kσₐ(T_{LA}/T_{A}).
2. Those securities satisfying the relationship are selected for possible trading at the market.
Steps for claim 2:
1. A group of securities potentially desired to be traded are tested on a computer or computer server using a computer program for satisfaction of relationships CC_{LA}≧2CC_{A}(T_{LA}/T_{A}), CC_{LB}≧2CC_{B}(T_{LB}/T_{B}) and/or CC_{LA}≧2kσₐ(T_{LA}/T_{A}), CC_{LB}≧2kσ_{b}(T_{LB}/T_{B}).
2. Those securities satisfying the relationship are selected for possible trading at the market.
Steps for claim 3:
1. A group of securities potentially desired to be traded are tested on a computer or computer server using a computer program for satisfaction of relationships CC_{LA}≧2CC_{A}(T_{LA}/T_{A}) and/or CC_{LA}≧2kσₐ(T_{LA}/T_{A}).
2. Those securities not satisfying the relationship are excluded from possible trading at the market.
Steps for claim 4:
1. A group of securities potentially desired to be traded are tested on a computer or computer server using a computer program for satisfaction of relationships CC_{LA}≧2CC_{A}(T_{LA}/T_{A}), CC_{LB}≧2CC_{B}(T_{LB}/T_{B}) and/or CC_{LA}≧2kσₐ(T_{LA}/TA), CC_{LB}≧2kσ_{b}(T_{LB}/T_{B}).
2. Those securities not satisfying the relationship are excluded from possible trading at the market.
